(19) United States
(12) Patent Application Publication
(10) Pub. No.: US 2014/0336544 A1
(43) Pub. Date: Nov. 13, 2014

(54) HOT/COLD RECOVERY CLOTHING

(71) Applicant: PATRICK DARBY RANSOM, Good Hope, GA (US)

(72) Inventor: PATRICK DARBY RANSOM, Good Hope, GA (US)

(21) Appl. No.: 14/273,260

(22) Filed: May 8, 2014

Related U.S. Application Data
(60) Provisional application No. 61/820,968, filed on May 8, 2013.

(51) Int. Cl. A61H 1/00

(52) U.S. Cl. CPC A61H 1/008; A61H 2201/02
USPC 601/18

(57) ABSTRACT

An apparatus for heating and/or cooling as well as compressing parts of the body. The apparatus includes one or more heatable freezable gel pads and an article of compression clothing or sleeve wherein the gel pad attaches to the compression sleeve using hook and loop closure. Used together, this apparatus allows wearer to apply heat or cold as well as compression to specific parts of the body that require such treatment.

### CROSS REFERENCE TO RELATED APPLICATIONS

This application claims the priority of U.S. Provisional Patent Application No. 61/820,968 entitled “HOT/COLD RECOVERY CLOTHING,” filed May 8, 2013, the contents of which are hereby incorporated by reference.

### FIELD OF THE INVENTION

The present invention relates to the use of cooling or heating gel in wearable clothing, sleeves, and braces for cooling or heating the human body.

### SUMMARY OF THE INVENTION

The present invention relates to cooling or heating gel to be used in clothing. The gel may be molded to form-fit the human body and be sealed between layers of fabric. For example, cooling/heating gel may be sealed within layers of PVC coated fabric and attached to inside of clothing using Velcro® for strategic heating and cooling. Specifically the gel may be frozen or heated to treat specific areas of injury or pain. The “hook” part of the hook and loop are permanently adhered to one surface of the gel pad. The recovery clothing features elasticized “loop” fabric as a featured inner layer of fabric that allows the gel pads to be strategically placed to target the specific affected area. Additionally, the gel may be used in hats, hard hats, compression bandages, and protective under-gear for athletes, soldiers, police, firemen, and the like.

### BRIEF DESCRIPTION OF THE DRAWINGS

FIG. 1 is a drawing showing the gel material placed in between two plasticized fabric sheets and adhesion of hook material for adhesion of gel pads to inner surface of textile.

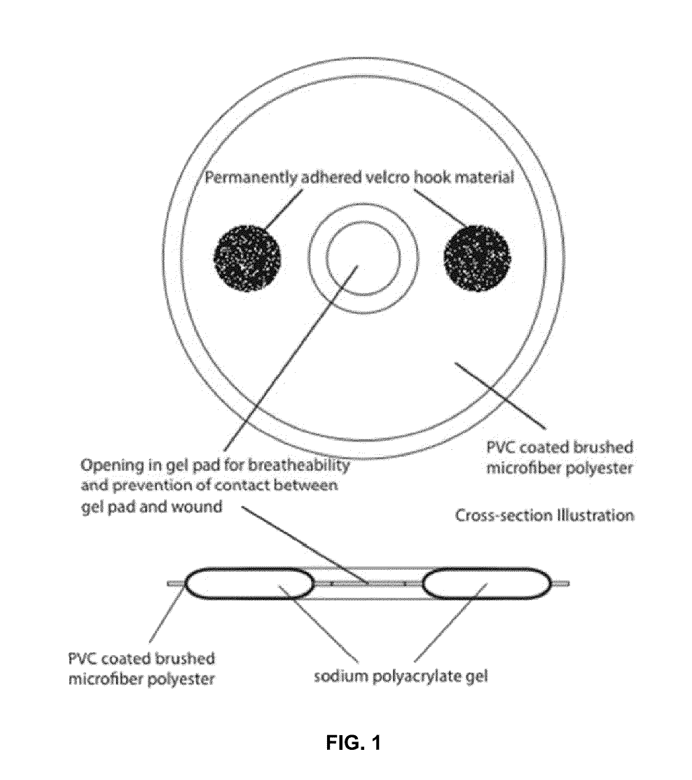

FIG. 2 is a drawing showing construction of sleeves and wraps by combining lycra/spandex/neoprene with elastic loop fabric for adhesion of gel pads to inner surface of textile.

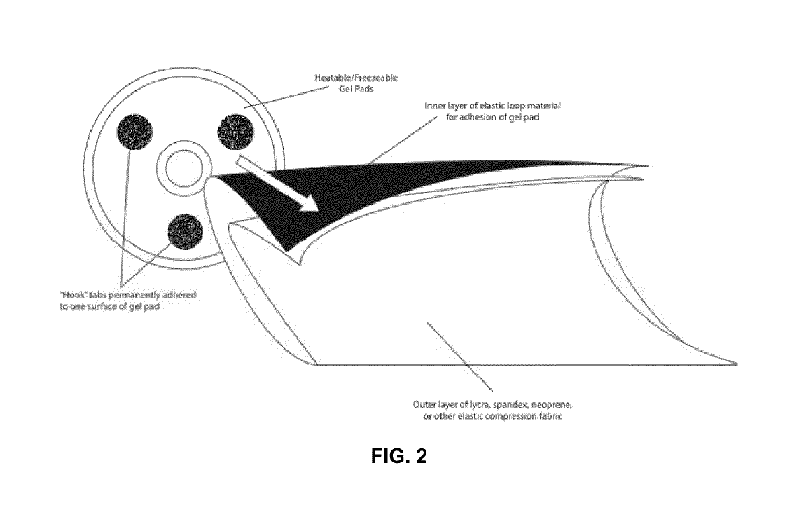

FIG. 3 is a drawing of a basic knee sleeve design having a cooling/heating gel-filled plasticized fabric pad secured by hook and loop to the inner surface of the compression sleeve.

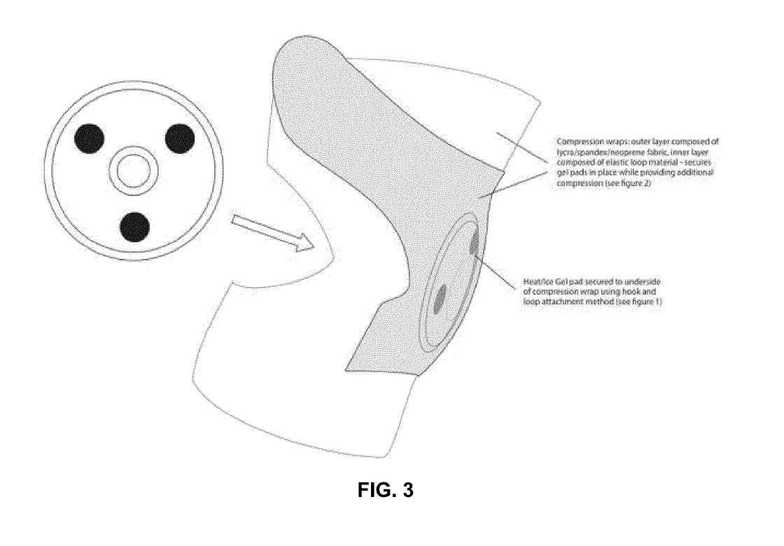

FIG. 4 is a drawing of a basic shirt design having a cooling/heating gel-filled plasticized fabric pad secured by hook and loop to the inner surface of the compression sleeve.

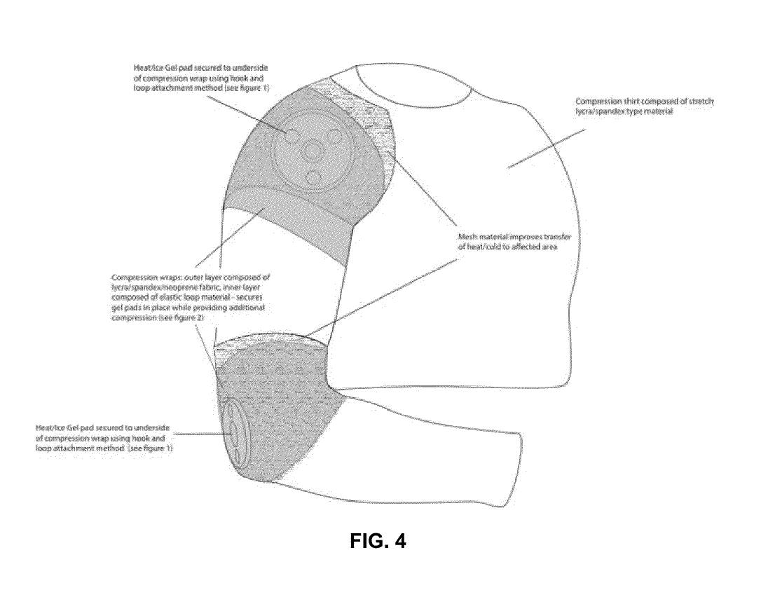

### DETAILED DESCRIPTION OF THE PREFERRED EMBODIMENTS

Cooling/heating gel material is sealed in plasticized fabric to form gel pad. It cools by refrigeration. This specific formulation stays soft when frozen. The gel pads are also heatable by microwave. An example formulation is Sodium Carboxymethyl Cellulose, Water, and Glycerin.

Gel pads feature cut-out hole in order to minimize contact between gel pad and any wound.

The gel pads are attached to inner surface of clothing—shirts, shorts, compression sleeves, joint supports (knees, ankles, elbows, shoulders, etc.), and recovery clothing—via hook and loop fabric. Materials for these articles of clothing include, compression fabric (including spandex, lycra, polyamide, neoprene, etc.), synthetic fabric, wicking fabric that pulls perspiration away from wearer's body, and mesh material.

Benefits

The hook and loop attachment method allows the heat and ice to be moved to target specific muscles and joints in need of treatment. The compression recovery gear prevents injury and speeds recovery by compressing and heating or cooling specific parts of the body before, during, and after exercise.

Treatment for muscle strain: P.R.I.C.E.—Protection, Rest, Ice, Compression, and Elevate.
Protection—Studies show that compression helps protect muscles from injury by providing stability.
Ice—Climate Gel when cooled can be used to ice down injured area—anti-inflammatory.
Compression—Compression gear can provide support and decrease swelling.

Gel pads attached by hook and loop method shirts/shorts/sleeves can be strategically placed to cool down “hot spots,” target specific muscles (especially muscles that are prone to injury or that have been injured), target specific joints (especially joints that have nagging injury, are prone to injury, or are recovering from surgery).

Gel pads can also be added to underside of protective gear such as shoulder pads or body armor by using hook and loop attachment method.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. An apparatus for heating and/or cooling as well as compressing parts of the body comprising:
compression clothing for providing compression on a selected body part;
a heatable and freezable pad affixed to said clothing;
wherein said clothing and said pad, when used together allows a wearer to apply heat or cold as well in combination with compression to specific parts of a wearer's body that requires such treatment.

2. The apparatus according to claim 1 wherein said pads are comprised of a gel.

3. The apparatus according to claim 1 wherein the gel pad is affixed with a hook and loop fastener.
